(19) United States
(12) Patent Application Publication
(10) Pub. No.: US 2016/0286953 A1
(43) Pub. Date: Oct. 6, 2016

(54) Multi-Angle Supports for Portable Electronic Devices

(71) Applicant: Carlos A. Castro, Garland, TX (US)

(72) Inventor: Carlos A. Castro, Garland, TX (US)

(21) Appl. No.: 15/016,058

(22) Filed: Feb. 4, 2016

Related U.S. Application Data
(60) Provisional application No. 62/111,813, filed on Feb. 4, 2015.

(51) Int. Cl. A47B 23/04; F16M 11/10

(52) U.S. Cl. CPC A47B 23/04; F16M 11/10

(57) ABSTRACT

Devices for one-piece support stands for portable electronics which preferably provide multiple viewing angles.

Priority is claimed from 62/111,813 filed Feb. 4, 2015, which is hereby incorporated by reference.

The present inventions teach multi-angle stands and holders for one or more personal electronics items such as iPads, iPods, tablets, smartphones, and other items having similar configurations. The stands consist of a single piece with no moving parts. The stands are easy to manufacture and can be made from e.g. wood, plastic, metal, or other materials.

For the purposes of description, the term “tablet” will be used to describe the generic personal electronic item to be used with the stand.

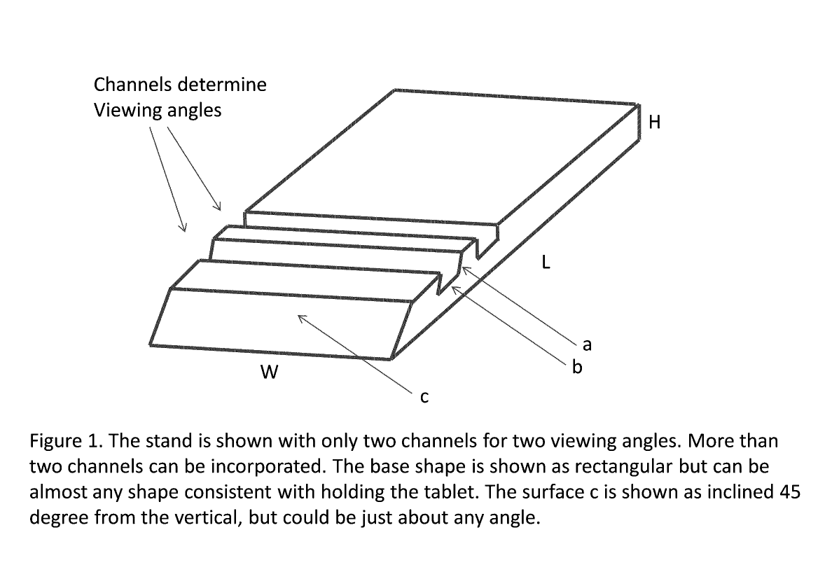

The exemplary stand of FIG. 1 consists of a single structure with channels situated along the top of the stand. Each channel provides a specific angle for viewing the tablet. For example, an angle of 28° from the vertical may be optimum for viewing, but an angle of 10° may be optimum for camera use in apps such as Facetime where an image of the user is transmitted when connected with a recipient. Although more than two angles can be incorporated, two will usually be sufficient for the presently-preferred embodiment. The 28° and 10° angles used here are examples. Other angles can also be used.

In the sample embodiment of FIG. 1, the stand is shown having a rectangular base, but any other shape, for example oval, could be used.

The length (L), width (W), and height (H) have very few constraints: L must be long enough to prevent the tablet from tipping over; W must be wide enough to allow placing the tablet in portrait or landscape orientation; H must be tall enough to allow the channel to be deep enough to hold the tablet. For each channel, the segment (a) must be configured for the correct viewing angle from the vertical and must be deep enough to allow the tablet to remain positioned in the channel on its own, without holding it. The bottom segment (b) of each channel must be wide enough to fit the thickness of the tablet and could be different from the other channel

This design allows the stand to hold tablets having different thicknesses as might be the case with different tablet manufacturers. The surface (c) is shown at a 45 degree angle with the vertical, but can be any aesthetically pleasing angle. The surface (c) can be used e.g. as a location for a nameplate for the owner. In FIG. 1, the channels are shown parallel to W, the width, but could be parallel to L, the length.

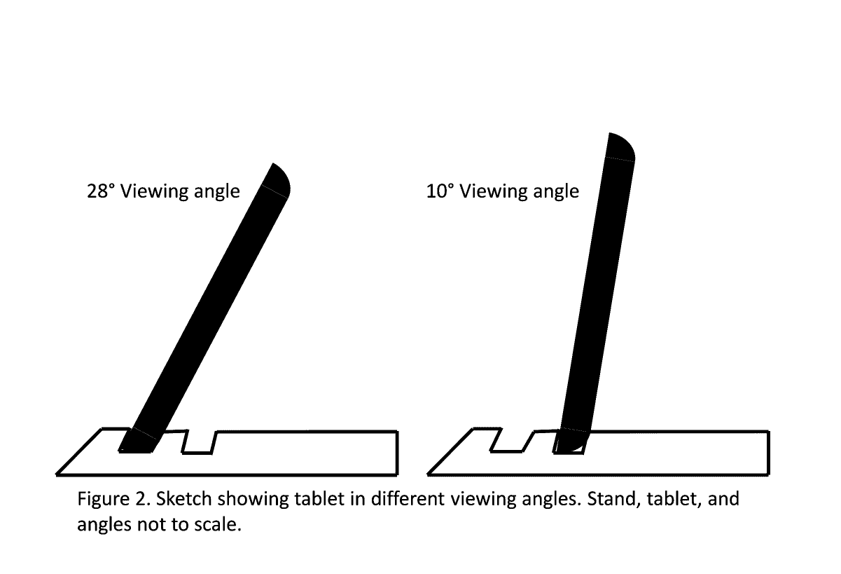

FIG. 2 shows a sample embodiment with a tablet in different viewing angles. Stand, tablet, and angles are not to scale.

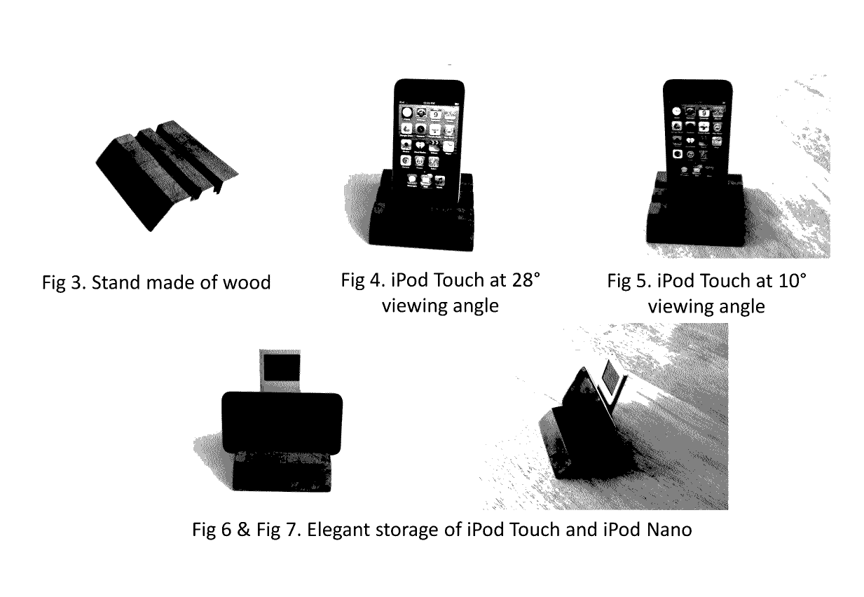

FIG. 3 shows a sample stand made of finished wood. The sample embodiments of FIGS. 4, 5, 6, and 7 show various use cases for a sample embodiment like FIG. 3.

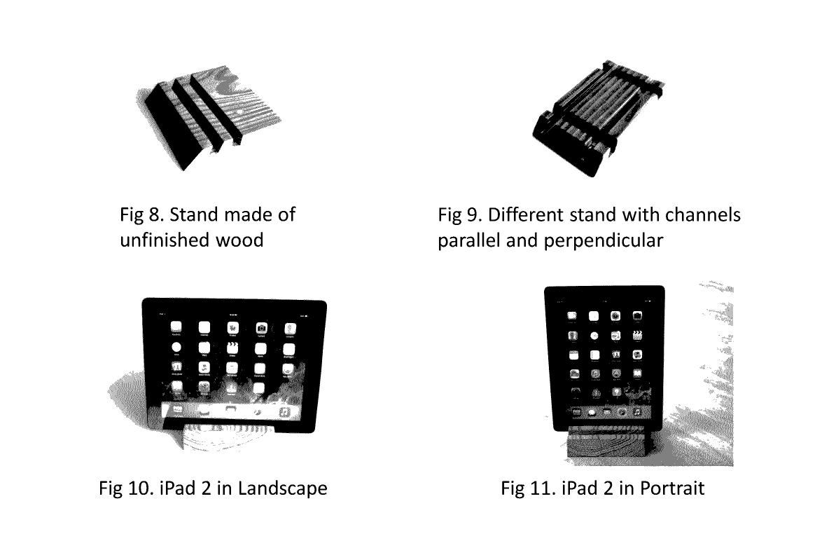

FIG. 8 shows another sample embodiment with a stand made of unfinished wood.

The exemplary stand in FIG. 9 has four channels, two 28° and two 10° parallel and perpendicular to the length.

FIGS. 10 and 11 show sample use cases for an embodiment like that of FIG. 8.

The disclosed innovations, in various embodiments, provide one or more of at least the following advantages. However, not all of these advantages result from every one of the innovations disclosed, and this list of advantages does not limit the various claimed inventions.
Multi angle
No moving parts
One piece construction
Robust
Easy to manufacture
Device can be placed in landscape or portrait orientations
Channel width allows for different size tablets
Easy one-hand drop-in placement of tablet on stand.
Low cost allows one-in-every-room. Many finishes, for example, finished wood to match office, den, bedroom, or kitchen furniture and white to match bathroom.
Small and light enough for canyon bag allowing use on airplane tray tables.
For tablets equipped with a magnetic side, the stand can incorporate a small permanent magnet in channel to allow tablet together with stand to be lifted simultaneously. Stand will not fall off when tablet is lifted.
Easy to slide on a flat surface such as a desk or table for pushaway uncluttering or for optimum positioning when using tablet camera for communication or selfies.
No-skid option by adding rubber feet to prevent sliding on airplane tray table.

Those of ordinary skill in the relevant fields of art will recognize that other inventive concepts may also be directly or inferentially disclosed in the foregoing. NO inventions are disclaimed.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

1. A system, method, or device exactly as described herein.

2. Systems, methods, devices, and/or components according to any portion of the description herein, insofar as enablingly disclosed herein.

3. Each and every novel structure, device, method for fabrication, method for design, method for use, business method, or other novel method or structure disclosed herein.

4. (canceled)
